(19) United States
(12) Patent Application Publication
(10) Pub. No.: US 2014/0184386 A1
(43) Pub. Date: Jul. 3, 2014

(54) INTERACTIVE LIGHTING EFFECT WRISTBAND & INTEGRATED ANTENNA

(71) Applicants: Jason Charles Regler, Wiltshire (GB); David Want, Warwickshire (GB); Bruce Clive Dearling, Wiltshire (GB)

(72) Inventors: Jason Charles Regler, Wiltshire (GB); David Want, Warwickshire (GB); Bruce Clive Dearling, Wiltshire (GB)

(73) Assignee: Regler Limited (a UK LLC No. 8556611), Meadow Lane, Westbury (GB)

(21) Appl. No.: 14/238,454

(22) PCT Filed: Aug. 10, 2012
(86) PCT No.: PCT/GB2012/051950

§ 371 Date: Feb. 11, 2014

(30) Foreign Application Priority Data
Aug. 11, 2011 (GB) 1113805.4
Dec. 1, 2011 (GB) 1120708.1

(51) Int. Cl. G08B 5/22

(52) U.S. Cl. CPC G08B 5/228
USPC 340/7.61

(57) ABSTRACT

A wristband (12) includes an RF receiver (34) arranged to receive targeted data burst (38). A controller (28) interprets the data bursts (38) to recover embedded activation codes that control operation of either individual wristbands (12) or a selected group of similar wristbands (12) worn by members of an audience at a venue (100) or event, such as a gig. Each wristband further includes at least one light emitting device (36), such as a high-intensity LED, and preferably multiple LEDs. In the event that a received data burst (38) is resolved to relate to (i.e. is addressed to) the wristband, a recovered activation code from that data burst is cross-referenced against LED control sequences stored in a memory (25) in the wristband (12). Particularly, the memory is pre-stored with at least one control sequence that is executable by the controller in response to identification of the corresponding activation code, with the control sequence arranged to cause selective illumination of the light emitting device(s) (36) to produce a light-show within wristbands (12) worn by the audience. The light show may include selective pulsing of one or more coloured LEDs. The light show can be based on zoned regions (102-110) within the venue (100) provided that individual wristbands are allocated with addresses for particular zones and the wristband's memory contains a zone activation code that is both included in the data burst (38) and resolved by the controller (28) as being relevant.

### FIELD OF THE INVENTION

This invention relates, in general, to an interactive lighting effect and is particularly, but not exclusively, applicable to electronic wristbands that can be selectively activated to energize light emitting devices integrated into each wristband to produce a coordinated display from individual wristbands worn by members of an audience at a show, such as a concert or a sporting event. In the exemplary context of an RF-based LED wristband, the present invention also relates to an integrated antenna.

### SUMMARY OF THE PRIOR ART

Silicone bracelets or wristbands, containing a message or logo and related to a cause, have become trendy and representative of social awareness or affiliation. Such bracelets are inexpensive to manufacture, with purchase at the point of sale helping to raise funds for a variety of charities or other good causes. Messages on such wristbands may, in fact, represent a sponsorship and thus directly providing a marketing tool for the sponsoring company.

Wristbands have also been used to demonstrate authorized admission into a venue, such as a concert hall, with the wristband including a serial number or other distinctive marker (such as a barcode) that can be scanned to authenticate the wristband and permits entry through a barrier or security checkpoint.

Wristband construction has used a variety of materials, including natural and synthetic braids and silicone rubber, with some wristbands further including a power source and integrated LEDs (or the like) that can be turned “on” or “off” and which flash. For example, the company FlashingBlinkyLights (of Sun Valley, Calif.) specialize in providing body lights and flashing jewellery.

Traditionally, crowd-based displays are concerted efforts within a crowd involving the bearing and display of cards or colours in unison. In the U.S. Ser. No. 11/482,245 (publication number US 2008/0007498) a handheld wand (comprising three high intensity LEDs of different colours) is triggered into activation using multiple beam scanning galvanometers that operates to target specific wands with a fast infrared pulse laser burst. The system exploits the property of temporal dithering afforded to galvanometer-controlled blazes to rapidly transmit independent signals to large areas for controlling the colour of an LED wand. The laser actuation method makes use of peoples persistence of vision and is the ability to hold a colour in place for a short that's delayed amount of time; this produces an effective pixel or point source. Also disclosed in US 2008/007498 is a shock-based approach to LED activation within a wand. More particularly, a shock sensor detects vibration induced in the wand by movement or collision (with a hard object) and then causes a controller to actuate a light pattern.

### SUMMARY OF THE INVENTION

According to a first aspect of the invention there is provided a wireless-addressable wristband having an identifying address, the wristband comprising: a memory having stored therein at least one pre-programmed light control sequence indexed by a corresponding activation code; an RF receiver arranged to receive an RF data burst and to recover an activation code therefrom should the RF data burst contain the identifying address of the wireless-addressable wristband; a controller responsive to the recovered activation code and coupled to the memory, the controller arranged or configured to execute said at least one light control sequence upon identification of the activation code in the received data burst; and at least one light source integrated into the wristband, the light source operationally responsive to the controller; wherein the controller is arranged or configured to cause the light source selectively to emit light in accordance with the pre-programmed light control sequence.

In a preferred embodiment, the memory stores a plurality of different light control sequences indexed by corresponding activation codes.

The wireless-addressable wristband may include a plurality of LED light sources (typically selected from the group containing at least the colours red, green, blue and white), and wherein each light control sequence is associated with a specific recoverable activation code with one or more received data bursts, each specific activation code arranged independently to control one or more of the plurality of LED light sources.

In another aspect of the invention there is provided a lighting system including a multiplicity of wireless-addressable wristbands according to the first aspect (and its preferred embodiments), wherein a first group of wireless-addressable wristbands is associated with a first zonal address and a second group of wireless-addressable wristbands is associated with a second zonal address different to the first zonal address and where the first group of wireless-addressable wristbands is selectively operationally responsive subject to receipt of a data burst including the first zonal address and the second group of wireless-addressable wristbands is selectively operationally responsive subject to receipt of a data burst including the second zonal address.

In yet another aspect of the invention there is provided a method of providing a lighting effect within members of an audience at an event or venue, at least one of the members of the audience provided with a wireless-addressable wristband according to the first aspect of the invention. More particularly, the method includes: recovering an embedded control signal for an audio track, the embedded audio track synchronized to at least one musical phrase of the audio track; communicating an RF data burst to at least one wristband, the RF data burst including LED illumination control information reflecting the embedded control signal of the audio track; receiving the RF data burst at said at least one wristband and recovering the LED illumination control information; and in the at least one wristband, executing synchronized LED illumination with said at least one musical phrase according to said recovered LED illumination control information.

Advantageously, the preferred embodiments of the present invention provide a low-cost, visually-stimulating lighting effect for crowds within an organized concert or meeting space. Use of specific actuation codes, sent in data bursts from an RF transmitter, permit zonal control of LED activation within an auditorium such that one or more zones may be activated contemporaneously to provide one or more colours in each of the targeted zones. The RF actuation code is interpreted by a controller in the wristband to instigate pre-set light patterns pre-programmed into memory in the wristbands. Alternatively, in an environment having a single zone through which a multiplicity of light emitting wristbands are distributed, groups of wristbands may be targeted based on an ID number or code assigned uniquely to each of those groups (or even unique to a single wristband). Consequently, lighting control is orchestrated by a centralized controller, with the lighting effects from individual wristbands distributed within the audience to promote collective audience participation and a global lighting effect within the audience at a show, event or gig.

In a preferred embodiment, the wristbands are made of a biodegradable braided material in which high-intensity LEDs are concealed. Alternatively, the materials may be hypoallergenic silicone with a wipe clean surface.

In another aspect of the invention there is provided a wireless-addressable wristband including an LED strip containing a plurality of LEDs coupled together via a conductor, at least a portion of the LED strip realizing an RF loop antenna arranged, in use, to receive modulated RF signals that are encoded with control instructions to actuate operation of the wireless-addressable wristband.

In a preferred embodiment, the loop antenna is unbroken, with first and second ends of the LED strip coupled across a processor-controlled switch that regulates power to the LED strip. Further, the LED strip may be fed through a light-transmissive sleeve.

The wireless-addressable wristband preferably has separate power supplies for a controller module and an RF receiver module, the controller module configured or arranged to regulate LED operation and the RF receiver module configured to arranged to recover data from incident modulated signals received via the loop antenna.

### BRIEF DESCRIPTION OF THE DRAWINGS

Exemplary embodiments of the present invention will now be described with reference to the accompanying drawings, in which: is

FIG. 1 is a schematic representation of a preferred system containing light emitting wristbands of a preferred embodiment of the present invention;

FIG. 2 is a representation of an auditorium zoned to support lighting effects actuated in accordance with a preferred control algorithm of the present invention;

FIG. 3 is a preferred zonal coding scheme for actuating wristbands within the system of FIG. 1;

FIG. 4 is a flow diagram of a lighting control regime permitting selective illumination of the LED wristbands of FIG. 1 in response to environment stimuli;

FIG. 5 is a schematic representation of a receiver circuit including an integrated antenna according to a preferred embodiment of the present invention;

FIG. 6 shows a partial circuit arrangement for implementing a combined antenna and LED lighting strip within FIG. 5; and

FIG. 7 is a rear perspective view of an LED RF wristband according to a preferred embodiment of the present invention.

### DETAILED DESCRIPTION OF A PREFERRED EMBODIMENT

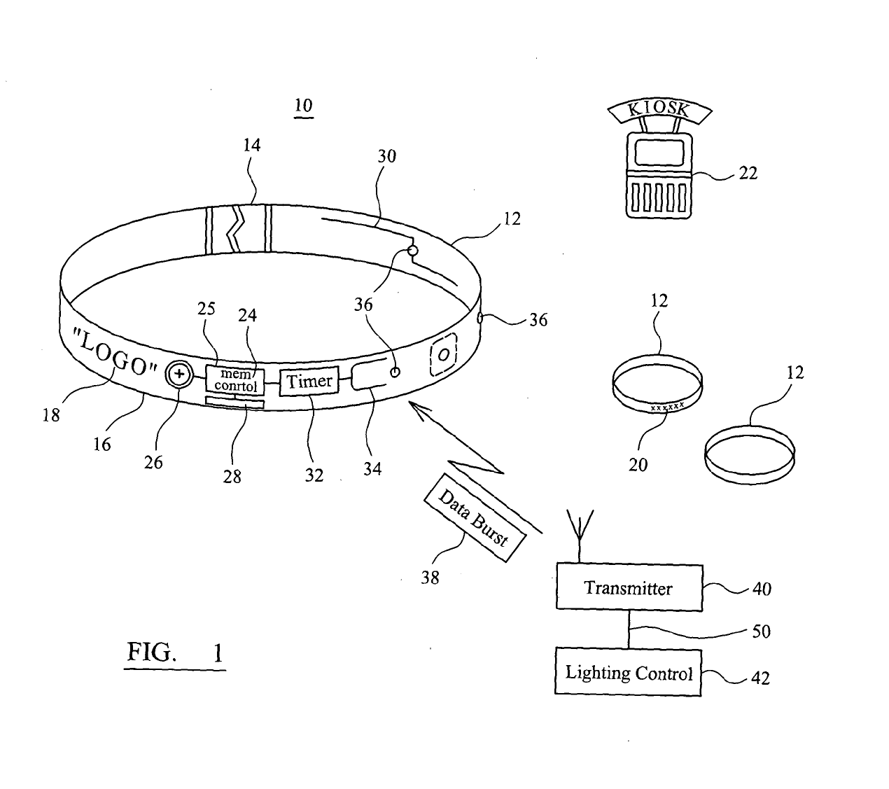

FIG. 1 is a schematic representation of a preferred system 10 containing multiple wristbands 12 (of which only one shown in detail and only three in total are illustrated).

Each wristband 12 may be formed in any suitable material, including biodegradable braiding or molded synthetic materials. If necessary, the wristband has an adjustable strap or clasp 14 (or the like) that permits shortening of the overall size of the wristband 12. An outer surface 16 man support the printing of a logo 18 or other information, such as a barcode 20. The barcodes 20 may be scannable to permit electronic verification of the authenticity of the wristband for entry purposes to a secure area, such as a concert arena.

The wristbands 12 may themselves be made of material containing coloured pigment and/or fluorescent and/or phosphorescent properties.

Wristbands 12 may be distributed at an event upon payment to an event organizer at a kiosk 22, which kiosk may be manned or configured as an electronic “ticket/wristband” dispensing machine containing an ATM. Alternatively, the wristbands may be pre-delivered using a postal service.

A variety of electronic components are integrated into the wristband 12. The components are preferably concealed by a sandwich of material that encases and protects at least some of the components. Typically, the wristband will include a controller 24 coupled to a local power source 26, such as a one-use DC watch battery or a thin film (rechargeable) lithium-ion battery.

The controller 24 is programmable through a suitable interface 28, which interface may take a variety of forms including a physical connection or a passively accessible contact. The controller 24 therefore includes memory 25 containing executable program code and storage space for allocated identification data (or the like). Alternatively, a discrete memory could also be provided.

In certain embodiments, circuitry 30 contained within the wristband 12 may include a timer or clock 32 coupled to the controller 24. The clock 32 may be used to synchronize lighting effects, as will be explained later.

In a preferred embodiment, the wristband 12 includes an RF receiver 34, including a printed antenna. Such RF receivers 34 are well-known in the art so it is suffice to say that the receiver circuit is coupled to the controller 24 so that targeted (in the sense of addressed) data bursts can be received by each wristband and interpreted by its respective controller 24. The skilled addressee will readily appreciate circuit requirements and configurations since these are commonly understood.

In addition, each wristband 12 contains at least one high-intensity LED device 36 (or other controllable light-emitting device) operationally responsive to a control signal issued by the controller 24 in response to recovered instructions from an incident data burst 38. Preferably, each wristband 12 contains at least three separate LEDs emitting red, blue and green lights. Of course, the colours and quantities of LEDs in each wristband 12 is a designed choice and can be varied to satisfy particular lighting effects. For example, a wristband may include any white-light LED or only LEDs of one particular colour, e.g. orange.

Circuitry 30 within the wristband 12 may be presented on a single board, although it may also be preferably to split operational functions between RF reception and processing and a second for LED control.

The light emitting device may protrude from the outer surface 16 of the wristband or otherwise be discretely covered by a layer of material that either acts as a diffuser and/or is designed to hide the existence of the light source.

The system 10 also includes a transmitter 40 and, if necessary, repeater stations that provide appropriate RF coverage within an arena or venue. However, a high-power transmitter, such as a 0.5 W transmitter may be sufficient to ensure wristband actuation, irrespective of human density, multi-path or other attenuating obstacles. It has been recognized that in any concert environment, especially any rock concert, line of sight between a strategically placed antenna (mounted, for example, on a gantry) and an individual wristband is likely to occur frequently on the basis that concerts-goers often will raise their hands above their heads and move their hands in time to music. Consequently, wristband LED activation for a selected group of wristbands will likely occur within a very short period of time, if not instantaneously (with or without any prompts issued by a stage management board). Data bursts 38 may therefore be repeated for a fixed duration, with each data burst targeted using a unique activation code assigns to one or more of the wristbands.

While one embodiment may make use of a programmed clock 32 to synchronize output of light from LED devices 36, an alternative embodiment makes use of a lighting controller 42.

In the first case, the wristbands' controllers are each programmed with a synchronized time-base for a particular event, with each controller configured to initiate at least one illumination event at a pre-programmed time and for, potentially, a fixed duration. The clock 32 may therefore trigger the controller to power up a selected arrangement of one or more LED devices 36 at, for example, (i) midnight on a particular day; or (ii) to increase gradually the number of differently coloured LED devices that are activated from a fixed point in time, e.g. first red, then red and blue, then only white; and/or (iii) to change sequencing of lights relative to a selected trigger time to generate different optical patterns. Indeed, a countdown function could, in fact, be triggered by simply making an electrical contact with an internal battery, with this contact triggered by an instruction “pull tab on band” on a display screen above a performance stage.

A battery isolation tab may, however, be pulled at time of entry in the venue 100, with the wristband's controller configured to provide a preset flash sequence to notify the user that the wristband is functional.

The advantage of making use of a time-based trigger and a suitable crystal within the wristband is that the viewing of the concert via a television or computer relay would still permit a viewed to perceive association with the concert and concert-goers.

In the second case, a lighting controller 42 is coupled to the transmitter, with the lighting controller either (i) programmed with data burst trigger instructions for transmission to one or more wristbands at points in a show and/or (ii) otherwise having a user interface allowing manual command entry (that again gives rise to a suitable data burst transmission from the transmitter 40 to effect control of groups of wristbands). Programming of the wristband with one or more activation codes and/or a zonal address (see below) is generally considered to offer a greater degree of light source coordination, although circuit costs increase because of increased processing requirements.

In a preferred embodiment, the lighting controller makes use of a Digital MultipleX (DMX) technology permitting seamless integration with an entire sound/lighting set. DMX technologies (and its capabilities) are well understood by the skilled addressee, and supports a broadcast downlink protocol instruction that contains uniquely addressed packets of information targeted at slave device that are daisy-chained together using a universal DMX cable 50.

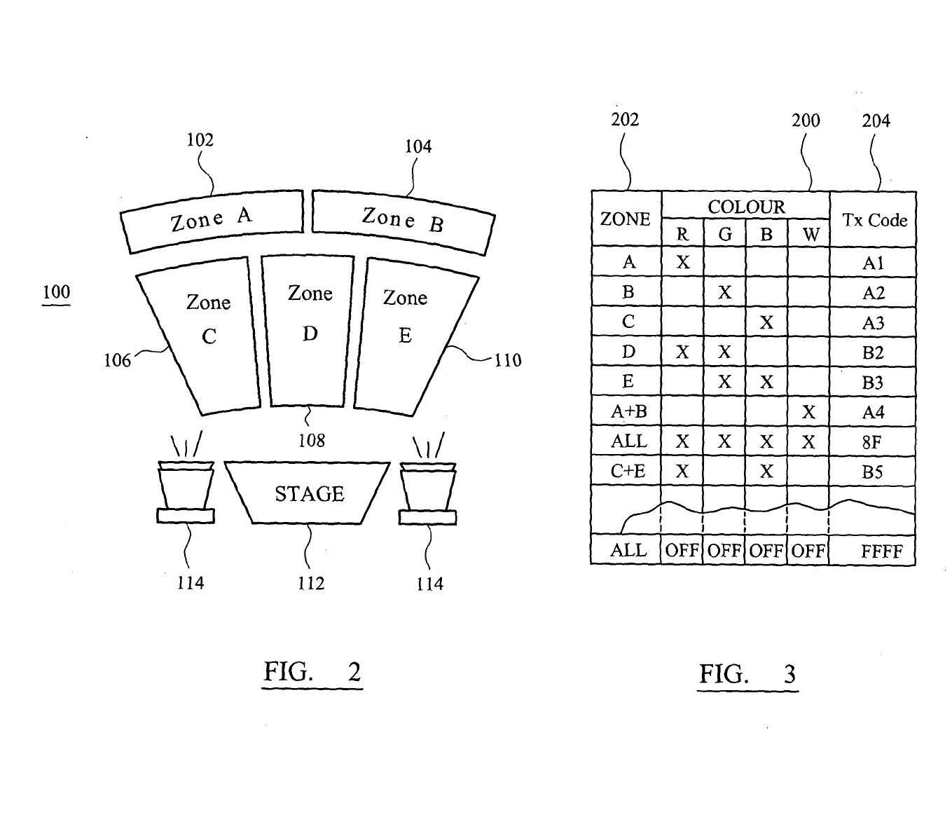

Turning to FIG. 2, a venue 100 is shown to be partitioned into (in an exemplary case) five zones 102-110 that extend in an arc outwardly from a stage 112 and accompanying speaker array 114. In accordance with a particular control algorithm, each zone is assigned a unique zonal address for correspondingly assigned wristbands 12. With the sale of each wristband, the interface (reference numeral 28 of FIG. 1) permits the wristband 12 to be programmed with the corresponding zonal address, with the address thereby allowing the lighting controller to target banks of wristbands on a selective sectional basis. Programming can occur at the point of sale (e.g. at kiosk 22) or at some other point, including via the interface 28 if this is connectable to a personal computer that has internet access (for example).

Of course, more or fewer zones may be present and, in the limit, there may only be one zone. However, the use of a zonal address is applicable in all cases since its transmission (in a data burst or over multiple data bursts 38) permits selective actuation of LEDs on the wristbands to support lighting effects within the venue 100. Of course, if the LEDs are synchronized to a common time base and make use of a clock 32, then the burst transmission is potentially ancillary to timed operation and, in the limit, can be omitted entirely to reduce the circuit complexity in the wristband. For example, use of a low power-consuming timer would avoid having to use an interface for programming purposes, although the time circuit would generally render the wristband as “single use”.

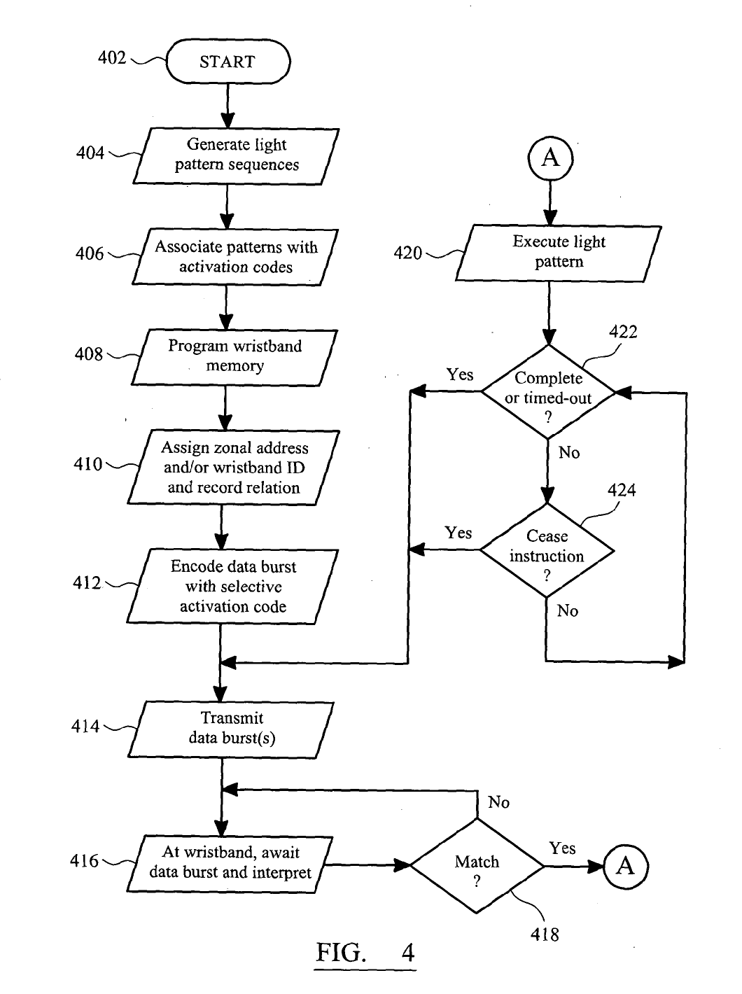

FIG. 3 is a preferred zonal coding scheme 200 (held in a database) for actuating wristbands within the system of FIG. 1. The database may reside at multiple points in the system, including at the kiosk (for initial programming) and also at the lighting controller to permit re-programming of the lighting effect based on knowledge of sales or a revision to a gig programme, including encores or delays arising during the show.

There are many ways to program the wristbands. The association between the incident activation code and the effect to be produced is stored locally in the memory 25 of the wristband 12. For example, in a first process, controllers of wristbands are programmed to interpret a data burst (such as a Hexadecimal Code, e.g. A 1) as meaning that the red LED is to be powered. The data burst 38 may be extended to include a zonal identity 202, such that only “Zone A” wristbands are actuated and only the red LED is powered. Similarly, individual blue and green LED activation would attract different hexadecimal codes, e.g. A2 and A3, respectively, with these activation codes 204 also being zone (or batch of wristband) specific. If two LEDs (say the red and green LEDs or the green and blue LEDs) were required to be actuated simultaneously, then this may involve the use of different codes for different zones (or batches of wristbands). Each code may, furthermore, initiate a specific pattern or rate of LED illumination, so the code 8F might activate all wristbands, with their respective controllers understood to follow a pre-programmed sequence of LED illumination (that was pre-stored in the memory 25 of the wristband's controller 24).

Programming of the light sequence executed by each wristband or programming at the DMX lighting controller 42 may be entirely synchronized to an event or happening within the venue 100, e.g. a specific song or portion of an act.

The lighting controller 42 may send out multiple contiguous instructions, so that different zones are simultaneously activated albeit that different zones may produce different colour effects, e.g. a first zone has wristbands only flashing red at a rate of one flash per second, whereas a second zone has its wristbands flashing green at a rate of twice per second. Further, the “on” duration may be set so as to ensure a substantial overlap between a majority of LEDs.

Assuming line of sight in an RF environment, activation of a majority of wristbands is generally coordinated. Upon receipt of an activation instruction (within the burst), the LEDs remain active either for a predetermined time (based, for example, on clock cycles) or until a specific light pattern has been completed

Cessation of either flashing or constant illumination of the LEDs in a wristband can be controlled through an “off” command, e.g. hex code “FFFF”. The “off” command can be targeted to specifically addressed wristbands, e.g. by using the zonal address, or otherwise can be a global instruction to all controllers in all active wristbands.

Any suitable coding scheme can be used and any suitable form of modulation applied, albeit that selection of the modulation scheme is generally selected to make use of free spectrum requiring no license. As will be appreciated, use of a relatively high power is offset (in license exempt frequencies, such as 869.5 MHz in the UK) by a requirement for a fairly slow baud rate (e.g. 10 kbps) and a transmission duty cycle that is no more than (typically) 10%. This means the transmitter can only send out a packet about one every one to two seconds (depending on packet length) which in turn depends on the complexity of the flash pattern. However, operating with an awarded licence would allow a different approach and potentially higher numbers of burst transmissions that, in a preferred embodiment, synchronize to a beat (either during in bar or preferably once every x number of seconds, where x is selected to ensure general time synchronization between beat and flash).

In one embodiment, a randomly selected wristband may be programmed with a unique code to permit that randomly selected wristband to be targeted and its wearer uniquely identified. Such a unique coding address may therefore permit the wearer to be given preferential treatment as a competition winner (within the global community of wristband wearers at the gig).

A wristband of one embodiment may include an array of LEDs (or even a small visual display unit, such as an OLED) that can function as a participant within a global lighting effect (as described above), but which can also present stored image data (pre-stored in local memory or otherwise transmitted to the wristband), e.g. promotional or advertising media materials.

Alternatively or additionally, the memory 25 can include downloadable files accessible via the interface 28 of the wristband 12, with these internal files including images and or music or other advertising/marketing media content.

FIG. 4 is a flow diagram 400 a lighting control regime permitting selective illumination of the LED wristbands of FIG. 1 in response to environment stimuli, e.g. an encoded RF data burst. The process begins 402 with the generation 404 of light pattern sequences for selective use in a show or event. The light pattern sequences are then associated 406 with activation codes, with the associations stored/programmed 408 in memory 25 in the wristbands 12. If appropriate, zonal addresses and/or wristbands IDs are associated 410 (i.e. stored) in each wristband to permit each wristbands to be addressed via an RF transmission, i.e. a targeted data bursts 38.

The wristbands are then distributed to members of an audience or participants at an event. At the event, data bursts are encoded 412 with selective activation codes that target one or more wristbands in one or more groups of wristbands in potentially one or more zoned areas at the venue. The data bursts are then transmitted 414.

The universe of wristbands at the event then awaits a suitably addressed data burst. And appropriately addressed data burst is then interpreted by the controller in the wristband 12 to recover the activation code. The controller essentially looks for a match 418 between the received activation code (within the data burst) and a corresponding cross-reference in the memory associated with the controller and located locally in the wristband. When a match is found, the controller executes the pre-programmed light pattern/sequence 420. The light pattern or sequence is then checked for completion or time-out 422 and, in the event of completion, the wristband returns to a monitoring state and thus awaits receipt of an appropriately addressed and relevant RF data burst. In the event that is the light sequence remains active, then the controller may optionally monitor 424 for a cease instruction issued by the lighting controller 42. If no cease instruction is identified, then the light sequence is continued until such time as it is deemed complete or is otherwise stopped.

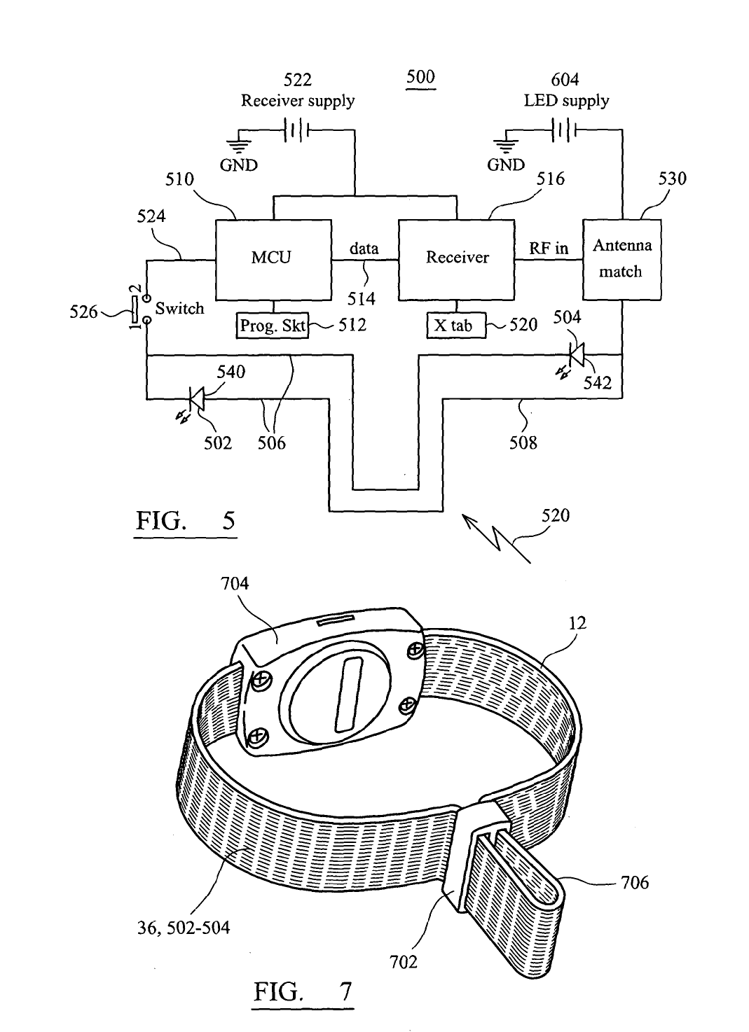

Referring to the schematic diagram of FIG. 5, there is shown a preferred radio frequency (RF) receiver 500 including an integrated antenna combined with a LED lighting effect strip 502. The use of RF is preferred since other transmission media (such as optical transmission) may be affected by a lack of line-of-sight. Licensed or unlicensed frequencies clearly affect component value selection, as will be understood.

Given the power consumption requirements for separate DC power supplies are preferably provided to supply LED lighting effect strip 506 and a RF receiver and micro-controller combination. Power requirements depend very much upon the form of the lighting circuit, with several LEDs within each strip potentially requiring an operating voltage generally in excess of four volts (4V) and preferably around 6V (at least at the outset). The controlling electronics and RF circuitry, conversely, might only require a nominal 3V supply, with battery life extended by having the receiver unit controllable enter a sleep mode and periodically wake-up to look for an incident control signal.

Specifically, in a preferred embodiment of FIG. 5, the wristband's LEDs are manufactured on an optional protective plastic casing having one or more LEDs 502-504 (or other light emitting devices) linked by (or coupled to) an electrical wire or trace 506, such as a copper wire. The wire operates as an antenna 508 for RF reception of modulated command data. Recovered demodulated data provides command signals that are interpreted locally to control lighting sequences and controlled burst light emissions from the LEDs 502-504.

A micro-controller 510 includes a programming socket 512 permitting software programming thereof. The micro-controller is responsive to data 514 that is output from a receiver 516, the data being recovered (i.e. demodulated) from an incident RF signal 520. The receiver 516 is typically an IC-based circuit, as readily known in the art. The receiver obtains clock synchronization from a crystal oscillator 520. The micro-controller 510 and receiver 516 preferably obtain power from a dedicated receiver power supply 522, as indicated above.

A pulse output 524 is coupled to a switch 526, such as a FET, to control operation thereof and to close a circuit through, parallel, LED lighting effect strip 506 that are coupled between the switch 526 and an antenna matching circuit 530.

A second power supply 532 provides power to the LEDs 504, 506.

The antenna matching circuit 530 provides a modulated signal (received from the antenna) to an input pin of the receiver 516. Typically, the antenna matching circuit 530 contains an inductor-capacitor network permitting impedance matching, antenna wavelength trimming/compensation to address the overall physical length of the antenna about substantially about the circumference of the wristband and, if necessary, appropriate band filtering. The design of such impedance matching networks is well known to the skilled addressee.

The antenna of a preferred embodiment therefore realizes a loop antenna, with end connections only at a printed circuit board level. The antenna 508 is effectively realized by the length of conductor between the anode 540 of a first LED 502 and the matching circuit, as will be understood, with a parallel LED strip providing a spur (having a minimal effect on circuit performance) that terminates at an anode 542 of a second LED 504 in that parallel LED strip.

The antenna 508 is in the general form of a full-wave loop antenna being approximately one wavelength long at 869 MHz; this is a license exempt frequency in Europe. The loop is formed from the output of the receiver, through the wristband conductors and via coupling capacitors to the “ground plane” of the printed circuit board. Alternatively, the antenna 508 may be realized as a half-wave (λ/2) or quarter-wave (λ/4) loop antenna.

Given that the lighting effect device is realized as a wristband (or the like, such as a lanyard), a physical external choke 702 permits fitting adjustment of the wristband 12, as shown in the perspective view of FIG. 7. The external choke 702 merely pinches the material of the wristband together and provides a shortening mechanism, but otherwise maintains the electrical integrity of the LED strip as it extends outwardly from a casing 704 for the circuitry and batteries and around (and preferably within) a material sleeve 706. The benefit of maintaining the integrity of the loop antenna (without breaks) is antenna performance, whilst a cost saving and part count reduction further arising from re-use of the LED strips in an ancillary function. Further, given the limited real-estate both within the circuit board case 704 and within the sleeve 706, the re-use of the conductor greatly simplifies assembly and connectivity of circuitry in the RF wristband 12 and ensures that the overall physical dimensions of the wristband are limited (whilst the lighting effect is both pronounced and effective).

The antenna 508 may be formed from multiple conductors that carry power to the LEDs, with these conductors isolated from a battery power supplies and switching components to allow more efficiently operation of the antenna.

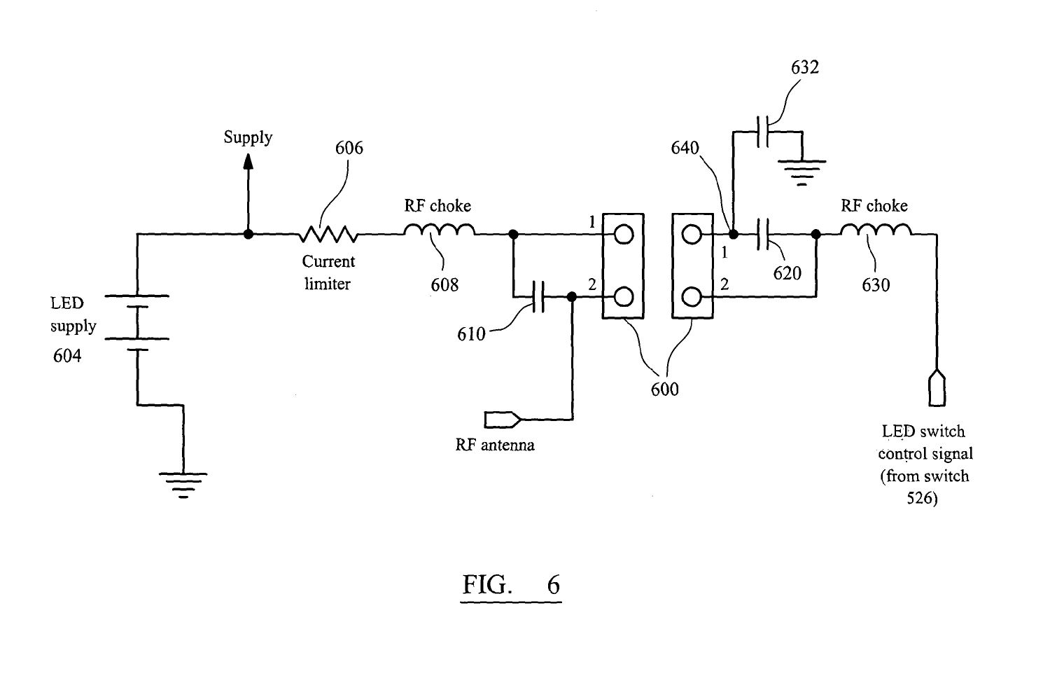

Turning to FIG. 6, circuit board connectors 600 provide connecting points for the conductors in the LED strips 506, with LEDs 502-504 in parallel and sitting across pins 1 and 2. The LED supply 604 is coupled to the LED strips through a current limiting resistor 606 and a first RF choke 608, such as an inductor. A first coupling capacitor 610 is coupled across first and second connecting points on a first circuit board connector, with the coupling capacitor 610 further coupled to the RF choke 608. A second coupling capacitor 620 is coupled across first and second connecting points on a second circuit board connector. The coupling capacitors 610 permits the use of both wires of the LED strips of the wristband 12 as the antenna.

The switch (reference number 526 of FIG. 5) allows current to pass from the LED battery via the current limiting resistor 606 and through the parallel connected LEDs to affect controlled illumination.

The switch 526 is also coupled through a second RF choke 630 and via the second coupling capacitor to the first connecting point on the second circuit board connector. The RF chokes 606, 630 therefore operate to isolate the antenna for the LED supply/battery 604 and the switch 526.

The “far end” of the antenna 508 is coupled through a grounding capacitor 632 to complete the antenna loop at a circuit node 640 between the second coupling capacitor 620 and the first connecting point on a second circuit board connector.

Circuit design, of course, may vary with selected carrier frequency. Moreover, FIG. 6 is representative of how a skilled person might implement a common conductor as an antenna when, in fact, the conductor principles serves a power supply purpose for LED illumination. The RF loop antenna-LED strip integrated arrangement may therefore be implemented independently of the mechanism for effecting lighting effect control, albeit that the arrangement of (for example) FIG. 5 is particularly beneficial for live-audience interactive events at concerts and the like.

It will, of course, be appreciated that the above description has been given by way of example only and that modifications in detail may be made within the scope of the invention. For example, rather than to use an address (communicated in a data burst) to actuate a wristband's lighting sequence, an alternative embodiment makes use of a pre-assigned channel (whether this is a timeslot in a time-division multiplexed system, a CDMA channel or a just frequency) assigned to a specific wristband or a group of wristbands. In this fashion, the channel is the wristband selector, and information contained on the channel is simply the activation code. At the wristband, the receiver is therefore tuned to the specific channel (to which it is assigned), so any embedded activation code on that specific channel is recoverable by the wristband's receiver 30 and is deemed relevant to the actuation of LEDs associated with the wristbands that are so tuned. In other words, the activation code for “flash red” is sent on channel 1, whereas the activation code for “flash red, blue and green) might be located on channel 2, with channel 1 and channel 2 assigned to the universe of wristbands or distinct (and possibly mutually exclusive) groups of wristbands. In effect, the use of an address “header” in the data burst is analogous to the identification of a particular channel. Consequently, the term “channel” should be understood to be a way of defining groups of wristbands.

The lighting controller can be arranged to embed and send activation codes (in data burst) either on a pre-assigned automated schedule or otherwise in response to a manual selection of an activation code and a manual keystroke instruction (or the like) through the console of the lighting controller.

In a further embodiment, the LED strip may be realised by use of a flexible PCB; this simplifies end connection of the LED string into the control and power circuitry by integrating the components. In fact, use of a flexible circuit board substantially reduces the function of the circuit board case 704 to that of holding battery cells and related terminal connections.

Furthermore, since the wristband is an interactive audience based-device, a preferred embodiment (based, for example, on FIG. 7) incorporates an RFID circuit configured to permit localized reading at, for example, an entry gate to an arena and/or at a point of sale (for the purchase of goods or services) within that arena. The RFID which, preferably, is a passive device not requiring direct power from the local battery used by the wristband to power its receiver electronics, therefore increases the functionality of the wristband. The RFID antenna is typically realized by a coil or circuit board trace, which coil or circuit board may be housed partially or totally within the circuit board case 704 and/or a material sleeve of the wristband through which a string of LEDs is threaded. Location of the RFID antenna is preferably remote from one or more battery cells used as a power supply for the RF circuit in the wristband, with the RFID antenna thereby isolated (to some extent) from the metal mass of the casing of the battery cells, i.e. the RFID is realised as an integrated track within a flexible PCB located within the wristband (rather than the circuit board case 704).

In a further embodiment, LED operation of the wristband is synchronized to an embedded control signal within the transmitted data burst. More specifically, an audio signal (or just a channel for a particular audio signal) stored on a music CD or the like is embedded with a control signal (such as a sub-audio CTCSS code or DTMF signal that can effect an activation code) such that the embedded control signal can be detected and recovered by an audio player. The embedded signal can be set up to the beat of the music or otherwise to produce a pre-set LED effect at one or more given trigger points within the audio track or sequence. The recovered control signal is then transmitted (by an RF transmitter coupled to the audio player and responsive to conventional code/tone identification and recovery circuitry) on an RF control channel as an appropriately modulated data burst. The data burst, which can be used to address either on a targeted zonal basis or otherwise as a global command addressing all in-range wristband receivers, is then recovered at the wristbands' receivers such as to control synchronized illumination of the LEDs in accordance with the data burst's instructions/activation code. In this fashion, the embedded control signal in the audio (or video track, as the case may be) can achieve music beat synchronization with the beat or musical phrase of the audio (or video) track on the CD and can permit independent control of the LED. The RF communicated embedded code may therefore access pre-programmed LED illumination sequences stored in the wristbands memory, or otherwise may directly control the wristband's illumination.

The terms “zone” and “batch” should therefore be considered to relate to groups of wristbands that are selectively actuated based on location and/or time. Similarly, the term “wristband” is not limiting and can be considered to extend to other wearable articles, such as necklaces, bracelets or headbands and the like.

It will be understood that unless features in any of the particular preferred embodiments are expressly identified as incompatible with one another or the surrounding context implies that they are mutually exclusive and not readily combinable in a complementary and/or supportive sense, the totality of this disclosure contemplates and envisions that specific features of those complementary embodiments can be selectively combined to provide one or more comprehensive, but slightly different, technical solutions.

1. A wireless-addressable wristband (12) either having an identifying address or being responsive to a specifically assigned channel, the wristband comprising:
a memory (25) having stored therein at least one pre-programmed light control sequence indexed by a corresponding activation code;
an RF receiver (34) arranged to receive an RF data burst (38) and to recover an activation code (204) therefrom should the RF data burst contain the identifying address of the wireless-addressable wristband (12) or the data burst be present on the specifically assigned channel;
a controller (28) responsive to the recovered activation code and coupled to the memory, the controller arranged or configured to execute said at least one light control sequence upon identification of the activation code in the received data burst; and
at least one light source (36) integrated into the wristband (12), the light source operationally responsive to the controller (28);
wherein the controller is arranged or configured to cause the light source (36) selectively to emit light in accordance with the pre-programmed light control sequence.

2. The wireless-addressable wristband (12) according to claim 1, wherein the memory stores a plurality of different light control sequences indexed by corresponding activation codes.

3. The wireless-addressable wristband (12) according to claim 1 or 2, further including a plurality of LED light sources, and wherein each light control sequence is associated with a specific recoverable activation code with one or more received data bursts, each specific activation code arranged independently to control one or more of the plurality of LED light sources.

4. The wireless-addressable wristband (12) according to claim 1, 2 or 3, wherein wristband includes an interface (28) and the memory (25) includes a downloadable data file accessible via the interface (28).

5. The wireless-addressable wristband (12) according to any preceding claim, wherein the wireless-addressable wristband (12) is programmable with the identifying address.

6. The wireless-addressable wristband (12) according to any preceding claim, further including a scannable barcode or electronic signature that authenticates the wristband and permits entry through a barrier or security checkpoint.

7. The wireless-addressable wristband (12) according to any preceding claim, further including an RFID.

8. A lighting system including a multiplicity of wireless-addressable wristbands (12) according to any preceding claim, wherein a first group of wireless-addressable wristbands is associated with a first zonal address and a second group of wireless-addressable wristbands is associated with a second zonal address different to the first zonal address and where the first group of wireless-addressable wristbands is selectively operationally responsive subject to receipt of a data burst including the first zonal address and the second group of wireless-addressable wristbands is selectively operationally responsive subject to receipt of a data burst including the second zonal address.

9. The lighting system of claim 8, further comprising:
a DMX lighting controller (42) coupled to an RF transmitter (40), the DMX lighting controller arranged or configured to control data burst transmissions from the RF transmitter (40).

10. A method of providing a lighting effect within members of an audience at an event or venue (100), at least one of the members of the audience provided with an wireless-addressable wristband (12) according to any of claim 1 to 7, the method including:
recovering an embedded control signal for an audio track, the embedded audio track synchronized to at least one musical phrase of the audio track;
communicating an RF data burst to at least one wristband, the RF data burst including LED illumination control information reflecting the embedded control signal of the audio track;
receiving the RF data burst at said at least one wristband and recovering the LED illumination control information; and
in the at least one wristband, executing synchronized LED illumination with said at least one musical phrase according to said recovered LED illumination control information.

11. A wireless-addressable wristband (12) including an LED strip containing a plurality of LEDs coupled together via a conductor, at least a portion of the LED strip realizing an RF loop antenna (508) arranged, in use, to receive modulated RF signals that are encoded with control instructions to actuate operation of the wireless-addressable wristband.

12. The wireless-addressable wristband (12) of claim 11, wherein the loop antenna is unbroken, with first and second ends of the LED strip coupled across a processor-controlled switch regulating power to the LED strip.

13. The wireless-addressable wristband (12) of claim 11 or 12, the LED strip fed through a light-transmissive sleeve (706).

14. The wireless-addressable wristband (12) of claim 11, 12 or 13, including separate power supplies for a controller module and an RF receiver module, the controller module configured or arranged to regulate LED operation and the RF receiver module configured to arranged to recover data from incident modulated signals received via the loop antenna.
